(19) United States
(12) Patent Application Publication
(10) Pub. No.: US 2003/0187758 A1
(43) Pub. Date: Oct. 2, 2003

(54) Capital asset inventory system and method

(75) Inventor: James Douglas McKalko, Loveland, CO (US)

Correspondence Address: IBM CORPORATION, IPLAW IQ0A/40-3, 1701 NORTH STREET, ENDICOTT, NY, 13760, US

(73) Assignee: International Business Machines Corporation, Armonk, NY

(21) Appl. No.: 10/109,237

(22) Filed: Mar. 27, 2002

(51) Int. Cl. G06F 17/60

(52) U.S. Cl. 705/29

(57) ABSTRACT

An inventory system has an application engine for entering and validating data relating to an asset. The system also has a first inventory tool for automatically gathering data from a memory in the asset and storing it in a database within the inventory tool. The application engine stores the entered data in the database and merges it with the automatically gathered data there. The system also has a second inventory tool having a second database and is also adapted to perform an inventory function not available in the first tool. The application engine maps the merged data in the first inventory tool into the second database, thereby allowing one to perform the inventory function on the merged data.

### TECHNICAL FIELD

The invention relates generally to a system for entering, maintaining, and accessing inventory records for capital assets. More particularly the invention relates to a system and method for entering asset data using automatic scanning techniques and merging this data with manually entered data in a first inventory tool. The merged data is then accessed with a second inventory tool to perform inventory processes not provided by the first inventory tool.

### BACKGROUND OF THE INVENTION

Capital asset inventory data may be entered into a digital computer data system to maintain and account for the assets. For example, a typical inventory system would record each type of asset, such as a tool or workstation or the like, including its physical location in a building or office. Each item may have data relating to the item stored with the item in the form of a label, tag, or stored within a memory in the item. For example, a serial number, machine type, date installed, calibration records, inspection records, may be stored at the asset location. Other data relating to the item is also recorded such as cost, useful life, current book value, maintenance records, and owning department.

A person taking an inventory on a specific day may need to locate the item and verify the data stored at the item location. Various means have been devised to facilitate such verification including use of bar code labels. The person taking an inventory would then move from item to item directing a bar code reader at the various bar code labels. Filley, in U.S. Pat. No. 4,920,488 describes such a use of bar code labels.

Radio frequency identification (RFID) tags may also be used for gathering data stored at the item location. RFID techniques have advantages over bar code systems because RFID tags typically may store more data and are readable at a distance, not requiring a direct line-of-sight view by the reading apparatus. Brady et al., in U.S. Pat. No. 6,249,277B1 describe such an RFID tag. A hardware implementation of an RFID system is described in “Utilization of Radio Frequency for Asset Identification,” published in IBM Technical Disclosure Bulletin (TDB) September 1993 pp. 1-2.

Bowers et al. describe in their U.S. Pat. No. 6,195,006B1 use of RFID tags to maintain an inventory database of items in a library.

Other types of labels may also be used for similar purposes such as an adhesive tag carrying an encoded magnetic stripe or bar code such as is described in IBM TDB October 1976 p. 1828.

The physical location for an item may be obtained using Global Positioning Systems (GPS) apparatus such as described in the Filley patent listed above. Thierrin also describes use of GPS apparatus for location information in his article abstract “Asset inventory and management utilizing digital field data collection techniques,” published in Proc. of Geographic Information Systems/Land Information Systems, Denver, Colo., USA, November 1996 pp. 573-80.

As noted above, item data may also be stored in a memory at the asset location. Where the item is a workstation or has a memory connected to a communication link, asset data stored in the memory may be automatically gathered over the communication link. This process of remote asset data gathering shall be referred herein as scanning of the asset data. Soyack, in U.S. Pat. No. 4,456,790 describes such a system for gathering stored unique identity information from memory means in individual devices over a communication path.

Despite all of the development just described, there remains a need for better tools and techniques for asset inventory management. One such area needing improvement is the client/server environment where client assets particularly may be dispersed over large distances. Heidel describes the need in her article abstract “If it's client/server, it must be time to CYA (Control Your Assets),” published in CMG Proceedings v. 2 1996 Westmont, Ill., USA, pp. 685-691.

In accordance with the teachings of the present invention, there is defined a new asset inventory system and method which allows for enhanced operational capabilities. It is believed that such a system and method would constitute a significant advancement in the art.

### OBJECTS AND SUMMARY OF THE INVENTION

It is therefore a principal object of the present invention to enhance the asset inventory art by providing a system with enhanced data management capabilities.

It is another object to provide a system wherein entranced operational capabilities are possible.

It is yet another object to provide a method for managing asset inventory data which can be performed in a facile manner.

These and other objects are attained in accordance with one embodiment of the invention wherein there is provided an inventory system, comprising, an application engine for entering and validating first data relating to an asset, a first inventory tool having a first database, the first inventory tool adapted for automatically gathering and storing in the first database, second data on the asset via a communication connection between the first tool and the asset, a merging capability in the application engine, for storing the first data into the first database and merging the first data with the second data, via a communication connection between the application engine and the first inventory tool, a second inventory tool having a second database, the second inventory tool adapted to perform an inventory process not provided by the first inventory tool, and a mapping capability in the application engine, for mapping the merged first and second data from the first database in the first inventory tool into the second database in the second inventory tool via a communication connection between the application engine and the second inventory tool.

In accordance with another embodiment of the invention there is provided a method of maintaining inventory records, comprising the steps of, entering and validating first data relating to an asset into an application engine, operating a first inventory tool having a first database to automatically gather and store in the first database, second data on the asset, via a communication connection between the first tool and the asset, storing the first data into the first database and merging the first data with the second data, using the application engine, via a communication connection between the application engine and the first inventory tool, providing a second inventory tool having a second database, the second inventory tool adapted to perform an inventory process not provided by the first inventory tool, and mapping the merged first and second data from the first database in the first inventory tool into the second database in the second inventory tool, using the application engine, via a communication connection between the application engine and the second inventory tool.

### BRIEF DESCRIPTION OF THE DRAWINGS

FIG. 1 is a block diagram showing one embodiment of the present invention; and

FIG. 2 is a flowchart of a method embodiment of the present invention.

### BEST MODE FOR CARRYING OUT THE INVENTION

For a better understanding of the present invention, together with other and further objects, advantages and capabilities thereof, reference is made to the following disclosure and the appended claims in connection with the above-described drawings.

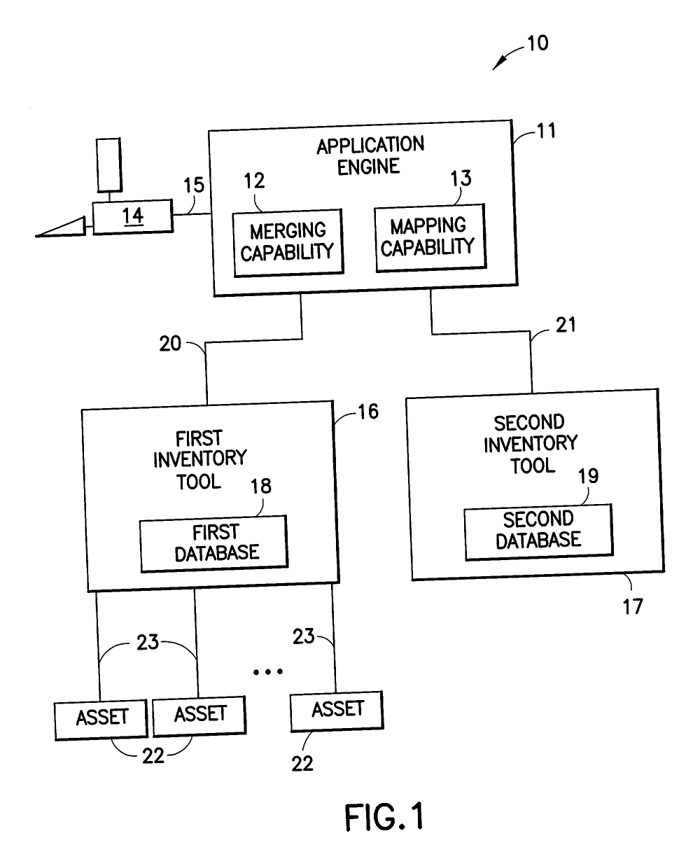

In FIG. 1 there is shown a capital asset inventory system 10 in accordance with the present invention. Application engine 11 may comprise software running on a processor of any type. Application engine 11 has a capability for entering and validating data relating to one or more assets 22. Data relating to an asset may, for example, be the date an asset was purchased or installed, purchase price, name of an employee responsible for the asset, physical location of the asset, or any other type of data. The data to be entered is not stored in a memory within the asset as some other data is which will be described below, but is typically entered manually using workstation 14 interconnected to application engine over attachment 15. The data may be entered using a keyboard, mouse, voice recognition apparatus or any other method of entering data into a workstation. The data may also be entered by inserting removable media such as a floppy disk, tape, or pluggable connection media into workstation 14. Data may also be entered by accessing a database over a network (not shown) from workstation 14 and sending the data to application engine 11 over attachment 15. The data is validated in application engine 11 using known data validation techniques including but not limited to automatically checking of dates for reasonableness. This validation is particularly valuable for detecting errors in manually entered data.

Application engine 11 may be implemented in software running on any type of processor, whether mainframe, workstation, microprocessor, laptop, handheld, palm device, wearable computer, or any other type of processor. Application engine 11 may also include any type of hardware or combinations of hardware and software capable of performing the functions described herein for said engine.

The inventory system 10 includes first inventory tool 16 having a first database 18 therein. Inventory tool 16 may be software, hardware, or a combination as just described for application engine 11. The software portion, if any, of tool 16 may be running on the same processor as the software, if any, of engine 11, or on a different processor in communication with engine 11.

First inventory tool 16 automatically gathers data from one or more assets 22 to which it has a communication connection 23. This data is retrieved from a memory device (not shown) within the asset 22. The memory device may be a non-volatile read only memory (ROM), ordinary random access memory (RAM), flash, serially addressable memory, hard drive, floppy drive, or any other type of memory known in the art for storing data. Examples of the type of data which may be stored in this memory in asset 22 includes the serial number of the asset, manufacture's codes, machine type, actual time in service, and calibration dates. Tool 16 gathers this data automatically without human intervention on some pre-determined schedule, whether periodically or not, and stores the data in first database 18 which may be any type of database known in the art including a sequential database, relational database or spreadsheet database.

Application engine 11 has within it merging capability 12 for merging the data entered above with the automatically gathered data in first database 18, using communication connection 20. The entered data is stored and merged in first database 18.

In the case where engine 11 and tool 16 are both software running on the same processor, connection 20 may comprise a software connection such as a common register, shared variable, or other software communication technique for exchanging data between programs. If engine 11 and tool 16 are software running on separate processors, connection 20 may comprise any type of connection between processors including a direct cable connection, network connection, fiber optic or coax link, dial up connection, or internet connection. Other configurations of software, hardware and connection for performing the described functions known in the art may be used without departing from the scope of the invention.

Merging shall be taken to mean the commonly understood process of combining one set of data with another. For example, the data may be combined for each particular asset, or by asset type, or by a date.

Second inventory tool 17, also a part of inventory system 10, has a second database 19, different from first database 18. Tool 17 may also be any combination of software and hardware. In addition, tool 17 is adapted to perform an inventory process not provided by tool 16. For example, tool 17 may be adapted to perform an IMAC (Install/Move/Add/Change) process which is not provided by tool 16.

When an asset such as a workstation attached to a network needs to be moved, the IMAC process is used to plan and execute the move including a network cable installation, network configuration, furniture dependencies, and new attachment hardware requirements.

Second inventory tool 17 may be a software product such as Tivoli Asset Management which is part of the Tivoli Service Desk Suite product line of Peregrine Systems, Inc. 3611 Valley Central Drive, San Diego, Calif. which provides an IMAC process as described above. McAfee Magic Total Service Desk also available from Peregrine Systems, Inc. may also be used for secondary tool 17.

If inventory capture is performed by first inventory tool 16 using, for example INTEL® LANDESK® Management Suite 6.5 software (INTEL AND LANDESK are registered trademarks of Intel, Corp., Santa Clara, Calif.) then the IMAC process above is not included in first inventory tool 16. MICROSOFT® SMS 2.0 (System Management Server) may also be used for first inventory tool 16 (MICROSOFT is a registered trademark of Microsoft Corporation, Redmond, Wash.).

There is a communication connection 21, similar to 20, between tool 17 and engine 11.

Application engine 11 has mapping capability 13 for mapping the merged data in first database 18 into second database 19 via communication connection 21. Those skilled in the art will recognize that mapping capability will necessarily include whatever data conversions are necessary depending on the type or organization of databases 18 and 19 when mapping therebetween.

Application engine 11 may be running on a second workstation different from workstation 14. Engine 11 may also be adapted to activate and run tools 16 and 17, whether on the same processor or separate processors. First and second inventory tools 16, 17, may also be stored in a memory on this second workstation.

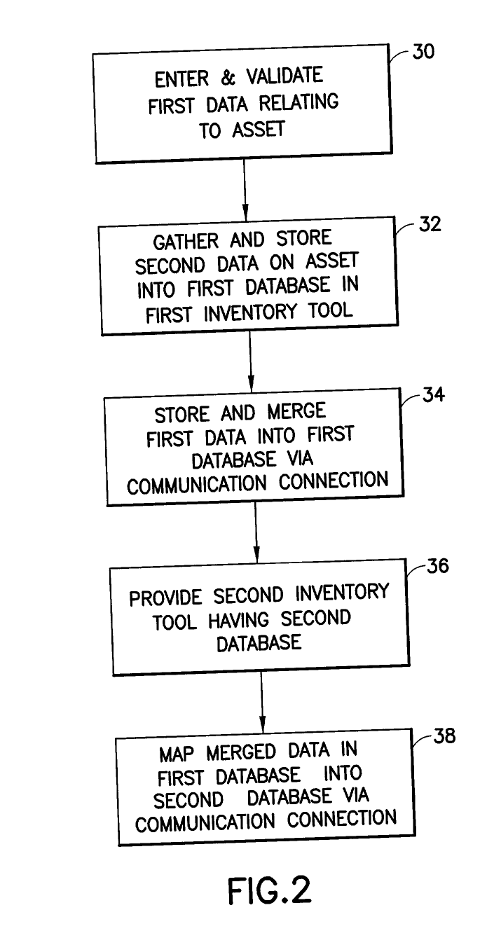

In FIG. 2 there is shown a flowchart for a method of maintaining inventory records in accordance with the present invention. In step 30 data relating to an asset is entered into an application engine. The data, which is not stored in a memory within the asset, is entered as explained above. A first inventory tool is operated in step 32 to automatically gather and store different data into a first database within the tool, via a communication connection between the tool and the asset.

In step 34, the application engine stores the entered data into the first database and merges it with the automatically gathered and stored different data there.

In step 36 a second inventory tool is provided, which is adapted to perform an inventory process not provided by the first inventory tool. The second tool has a second database. In step 38, the application engine maps the merged data in the first database into this second database via a communication connection between the application engine and the second inventory tool.

The second tool may now be used to perform the inventory process that was not available on the first inventory tool, on the merged asset data.

While there have been shown and described what are at present considered the preferred embodiments of the invention, it will be obvious to those skilled in the art that various changes and modifications may be made therein without departing from the scope of the invention as defined by the appended claims.

What is claimed is:

1. An inventory system, comprising:
an application engine for entering and validating first data relating to an asset;
a first inventory tool having a first database, said first inventory tool adapted for automatically gathering and storing in said first database, second data on said asset via a communication connection between said first tool and said asset;
a merging capability in said application engine, for storing said first data into said first database and merging said first data with said second data, via a communication connection between said application engine and said first inventory tool;
a second inventory tool having a second database, said second inventory tool adapted to perform an inventory process not provided by said first inventory tool; and
a mapping capability in said application engine, for mapping the merged first and second data from said first database in said first inventory tool into said second database in said second inventory tool via a communication connection between said application engine and said second inventory tool.

2. The system of claim 1, wherein said application engine is adapted to activate and run said first and second inventory tools.

3. The system of claim 1, wherein said asset is a first workstation.

4. The system of claim 1, further comprising a second workstation for running said application engine.

5. The system of claim 4, wherein said second workstation has a memory storing said first inventory tool.

6. The system of claim 4, wherein said second workstation has a memory storing said second inventory tool.

7. A method of maintaining inventory records, comprising the steps of:
entering and validating first data relating to an asset into an application engine;
operating a first inventory tool having a first database to automatically gather and store in said first database, second data on said asset, via a communication connection between said first tool and said asset;
storing said first data into said first database and merging said first data with said second data, using said application engine, via a communication connection between said application engine and said first inventory tool;
providing a second inventory tool having a second database, said second inventory tool adapted to perform an inventory process not provided by said first inventory tool; and
mapping the merged first and second data from said first database in said first inventory tool into said second database in said second inventory tool, using said application engine, via a communication connection between said application engine and said second inventory tool.

8. The method of claim 7, further comprising the step of activating and running said first and second inventory tools using said application engine.

9. The method of claim 7, wherein said asset is a first workstation.

10. The method of claim 7, wherein said application engine is used on a second workstation.

11. The method of claim 10, wherein said first inventory tool is operated on said second workstation.

12. The method of claim 10, wherein said second inventory tool is provided on said second workstation.

13. A computer program product configured to be operable to maintain inventory records, said computer program product comprising:
a processor;
an application engine adapted for running on said processor, for entering and validating first data relating to an asset;
a first inventory tool having a first database, said first inventory tool adapted for automatically gathering and storing in said first database, second data on said asset via a communication connection between said first tool and said asset;
a merging capability in said application engine, for storing said first data into said first database and merging said first data with said second data, via a communication connection between said application engine and said first inventory tool;
a second inventory tool having a second database, said second inventory tool adapted to perform an inventory process not provided by said first inventory tool; and
a mapping capability in said application engine, for mapping the merged first and second data from said first database in said first inventory tool into said second database in said second inventory tool via a communication connection between said application engine and said second inventory tool.

14. A computer program product for instructing a processor to maintain inventory records, said computer program product comprising:
a computer readable medium;
first program instruction means for entering and validating first data relating to an asset into an application engine;
second program instruction means for operating a first inventory tool having a first database to automatically gather and store in said first database, second data on said asset, via a communication connection between said first tool and said asset;
third program instruction means for storing said first data into said first database and merging said first data with said second data, using said application engine, via a communication connection between said application engine and said first inventory tool;
fourth program instruction means for providing a second inventory tool having a second database, said second inventory tool adapted to perform an inventory process not provided by said first inventory tool; and
fifth program instruction means for mapping the merged first and second data from said first database in said first inventory tool into said second database in said second inventory tool, using said application engine, via a communication connection between said application engine and said second inventory tool; and wherein
all said program instruction means are recorded on said medium.
